(19) United States
(12) Patent Application Publication
(10) Pub. No.: US 2010/0309215 A1
(43) Pub. Date: Dec. 9, 2010

(54) DISPLAY APPARATUS

(75) Inventor: Yusuke YAMADA, Shiojiri (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/791,187

(22) Filed: Jun. 1, 2010

(30) Foreign Application Priority Data
Jun. 4, 2009 (JP) 2009-134770
Jan. 15, 2010 (JP) 2010-006563

(51) Int. Cl. G09G 5/02

(52) U.S. Cl. 345/589

(57) ABSTRACT

A display apparatus includes: a display device on which a tincted, including black, image is displayed; a position retrieving section that retrieves a position specified on a screen of the display device; and a controller that uses the position retrieved by the position retrieving section to identify a region specified on the screen of the display device and controls the region identified on the display device so that a untincted figure that is formed in a predetermined shape is displayed in the identified region.

### BACKGROUND

1. Technical Field

The present invention relates to a technique for selecting a region that is included in an image.

2. Related Art

JP-A-2007-11499 discloses a device that allows a user to easily recognize a region that is selected by the user and is included in an image. The device displays, on a display unit, a frame that represents the region selected by the user. The position and size of the frame is changed by dragging a mouse. When the frame is positioned in a dark portion of the image displayed by the device, the brightness of an image portion that is located outside of the frame is increased. When the frame is positioned in a bright portion of the image, the brightness of an image portion that is located outside of the frame is reduced. Thus, the region specified by the frame can be easily recognized by the user.

When the size of a black frame is changed by dragging a mouse, a displayed image is partially rewritten many times until a region is fixed. Therefore, in a display device (such as an electrophoretic display device or an electrochromic display device) on which a ghost of an image may remain until ghost reduction operation is done, a trace of a black frame faintly remains and degrades a displayed image.

### SUMMARY

An advantage of some aspects of the invention is that it provides a technique for preventing an image from being degraded when a region is being specified on a display device (such as an electrophoretic display device or an electrochromic display device) on which a ghost of an image may be generated.

According to a first aspect of the invention, a display apparatus includes: a display device on which a tincted, including black, image is displayed; a position retrieving section that retrieves a position specified on a screen of the display device; and a controller that uses the position retrieved by the position retrieving section to identify a region specified on the screen of the display device and controls the region identified on the display device so that a untincted figure that is formed in a predetermined shape is displayed in the identified region. According to the invention, since the untincted figure is displayed in the region specified by a user, the image is not degraded when the region is specified compared with image degradation that occurs when a black frame is used to specify the region.

It is preferable that the controller controls the region identified on the display device such that an operation for displaying the figure and an operation for hiding the figure are alternately performed at a predetermined time interval. In this case, since the operation for displaying the figure (that is formed in the predetermined shape) in the region specified by the user and the operation for hiding the figure (that is formed in the predetermined shape) are repeated, the user can easily recognize the specified region.

According to a second aspect of the invention, display apparatus includes: a display device on which a tincted, including black, image is displayed; a position retrieving section that retrieves a position specified on a screen of the display device; and a controller that uses the position retrieved by the position retrieving section to identify a region specified on the screen of the display device and controls the region identified on the display device so that either a tincted figure that is formed in a predetermined shape or a untincted figure that is formed in a predetermined shape is displayed in the identified region on the basis of the ratio of the area of a tincted portion of the image displayed on the display device to the area of a untincted portion of the image displayed on the display device. In this case, since the figure that represents the region is tincted or untincted on the basis of the ratio of the area of the tincted portion of the displayed image to the area of the untincted portion of the displayed image, the visibility of the image, which is obtained when the region is specified, is improved.

It is preferable that the display apparatus further include: an operating section that is operated by an operation; and a storage section that stores image data that represents the image, wherein the controller controls the display device on the basis of the operation to cause the image represented by the image data stored in the storage section to be displayed on the display device and controls the region identified on the display device so that when the area of the untincted portion is larger than the area of the tincted portion, the untincted figure is displayed and that when the area of the untincted portion is not larger than the area of the tincted portion, the tincted figure is displayed. In this case, since when the area of the untincted portion is larger than the area of the tincted portion, the untincted figure is displayed. Thus, the image is not degraded when the region is specified compared with image degradation that occurs when the tincted figure is used to specify the region. In addition, when the area of the untincted portion is not larger than the area of the tincted portion, the tincted figure is displayed in the region specified by the user. Since the area of the tincted portion is large, however, a difference between the region and a tincted portion located around the region is not noticeable even when the image displayed in the region specified by the user is rewritten and a ghost of the image is generated on a narrow area such like some glyph.

It is preferable that the controller controls the region identified on the display device such that an operation for displaying the untincted figure or the tincted figure and an operation for hiding the untincted figure or the tincted figure are alternately performed at a predetermined time interval. In this case, since the operation for displaying the figure (that is formed in the predetermined shape) in the region specified by the user and the operation for hiding the figure (that is formed in the predetermined shape) are repeated, the user can easily recognize the specified region.

It is preferable that a ghost of the image remains on the display device when the image displayed on the display device is hidden. It is also preferable that the display device is an electrophoretic display device. It is also preferable that the display device is an electrochromic display device.

### BRIEF DESCRIPTION OF THE DRAWINGS

The invention will be described with reference to the accompanying drawings, wherein like numbers reference like elements.

FIG. 1 is an outline view of an information display apparatus according to an embodiment of the invention.

FIG. 2 is a block diagram showing a hardware configuration of the information display apparatus.

FIG. 3 is a flowchart of a process that is performed by a CPU.

FIG. 4 is a diagram showing an image displayed on a screen of a display device.

FIG. 5 is a diagram showing an image displayed on the screen of the display device.

FIG. 6 is a diagram showing an image displayed on the screen of the display device.

FIG. 7 is a flowchart of a process that is performed by the CPU.

FIG. 8 is a diagram showing an image displayed on the screen of the display device.

### DESCRIPTION OF EXEMPLARY EMBODIMENTS

### Embodiment

### Configuration

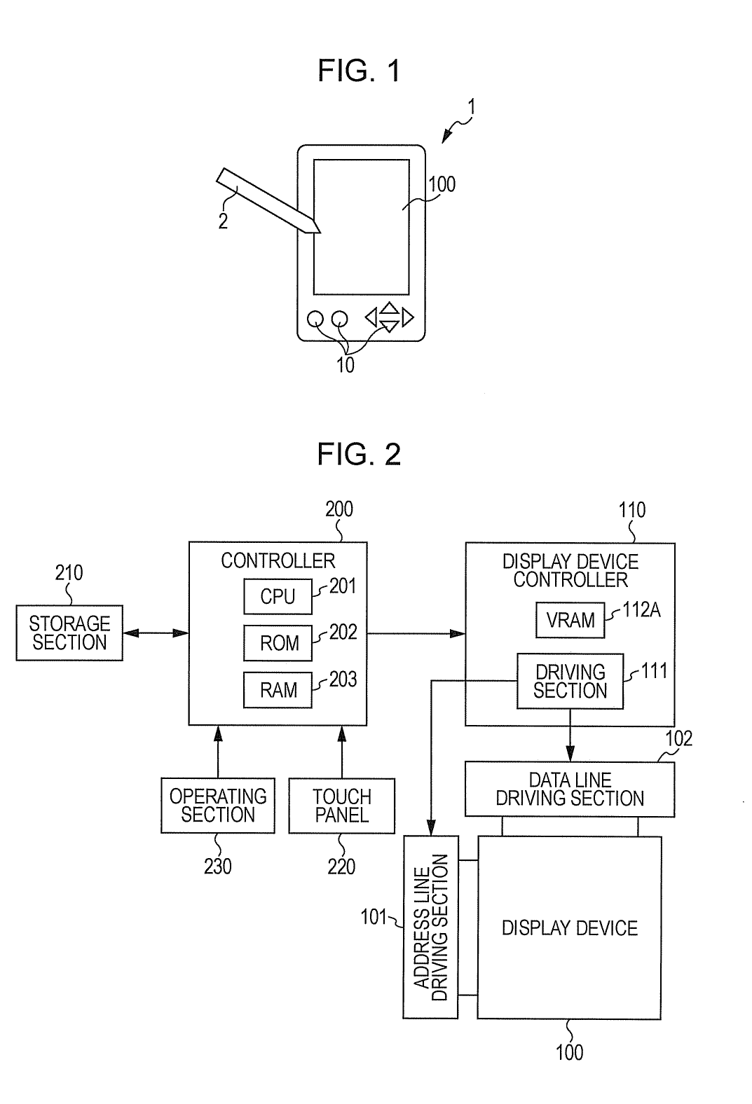

FIG. 1 is an outline view of an information display apparatus 1 according to an embodiment of the invention. The information display apparatus 1 displays images such as characters, figures and pictures. The information display apparatus 1 is formed in a rectangular plate-like shape. The information display apparatus 1 includes: a display device 100 that displays an image; and buttons 10 that serve as an operating section and are used to operate the information display apparatus 1. A transparent touch panel (not shown) is mounted on the surface of the display device 100. A stylus pen 2 is used to specify coordinates on the touch panel. The surface of an edge portion of the stylus pen 2 is curved to prevent the touch panel and the display device 100 from being scratched or damaged. The information display apparatus 1 can be operated by causing the stylus pen 2 to contact the touch panel in a similar manner to an operation performed by dragging or clicking with a mouse.

FIG. 2 is a block diagram of a hardware configuration of the information display apparatus 1. The display device 100 is an electrophoretic display device and includes two substrates and micro-capsule type electrophoretic elements that are located between the two substrates. The display device 100 is capable of displaying a white image, a black image and a gray image. In this case, the white image can be regarded as an untincted image, and the black image can be regarded as a tincted image. The display device 100 is driven by an active matrix driving scheme. A plurality of address lines and a plurality of data lines are included in the display device 100. The address lines extend in a lateral direction of the display device 100, while the data lines extend in a longitudinal direction of the display device 100. An address line driving section 101 has a circuit that applies voltages to the address lines of the display device 100. The voltages are applied to the address lines by a display device controller 110. A data line driving section 102 has a circuit that applies voltages to the data lines of the display device 100. The voltages are applied to the data lines by the display device controller 110.

The display device controller 110 has a driving section 111 and a video random access memory (VRAM) 112A. The VRAM 112A stores an image that is to be displayed on the display device 100. The driving section 111 has a circuit that controls the address line driving section 101 and the data line driving section 102. The driving section 111 controls the address line driving section 101 and the data line driving section 102 on the basis of the image stored in the VRAM 112A so that the image is displayed on the display device 100.

A controller 200 has a central processing unit (CPU) 201, a read only memory (ROM) 202 and a random access memory (RAM) 203. The controller 200 is connected to the display device controller 110, a storage section 210, the touch panel 220 and the operating section 230. The CPU 201 is operated on the basis of a control program stored in the ROM 202 to control the display device controller 110 and the storage section 210. In the embodiment, the controller 200 controls the display device controller 110 to control the display device 100 so that the image is displayed on the display device 100. Thus, the controller 200 and the display device controller 110 serves as a controller that controls the display device 100.

The storage section 210 has a nonvolatile memory and stores image data that represents images such as characters, figures and pictures. The transparent touch panel 220 is mounted on the surface of the display device 100. When an object contacts the surface of the touch panel 220, the touch panel 220 outputs, to the controller 200, a position signal that represents the position of a portion (of the touch panel 220) that the object contacts. The image that is displayed by the display device 100 is transmitted through the touch panel 220. The operating section 230 has the buttons 10. When one of the buttons 10 is pressed, a signal that represents the pressed button 10 is output to the controller 200. When the CPU 201 receives a signal from the touch panel 220 or one of the buttons 10, the CPU 201 controls the display device controller 110 so that the image is displayed on the display device 100.

### Operations

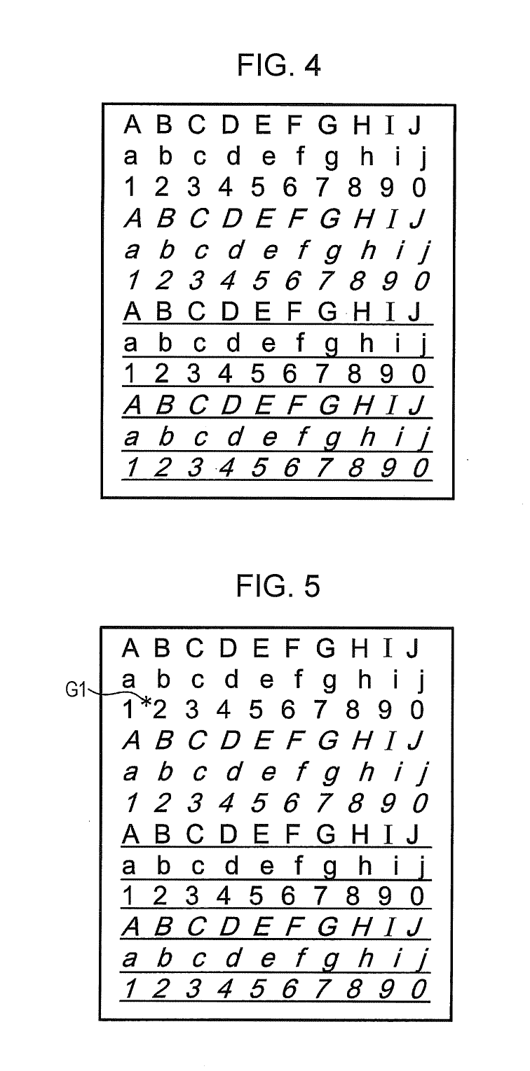

Operations of the information display apparatus 1 according to the embodiment are described below. When a user operates the operating section 230 to give an instruction to display an image whose data is stored in the storage section 210, the CPU 201 reads the image data from the storage section 210 and writes the image of the read image data into the VRAM 112A. When the CPU 201 has completed the operation for writing the image into the VRAM 112A, the CPU 201 outputs, to the display device controller 110, a signal that instructs displaying image. When this signal is input to the display device controller 110, the driving section 111 controls the address line driving section 101 and the data line driving section 102 on the basis of the image stored in the VRAM 112A. Then, voltages are applied from the address line driving section 101 and the data line driving section 102 to the display device 100 so that the image stored in the VRAM 112A is displayed on the display device 100. When the image of the image data is a character string image, a character string is displayed as shown in FIG. 4.

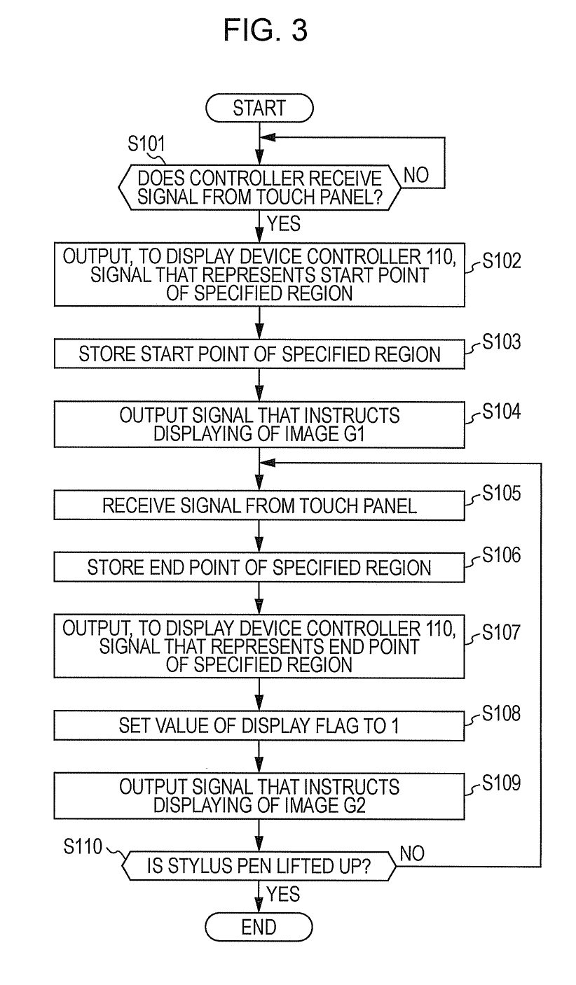

When the user operates the operating section 230 to start an operation for specifying a region in the displayed image and then causes the stylus pen 2 to contact the touch panel 220, the touch panel 220 outputs a signal that represents the position of a portion (of the touch panel 220) that the stylus pen 2 contacts. When the controller 200 receives the signal from the touch panel 220 (or when the answer in step S101 shown in FIG. 3 is affirmative), the CPU 201 outputs, to the display device controller 110, a signal that represents the position (start point of the specified region) of the portion that the stylus pen 2 is contacting (in step S102). When the display device controller 110 receives the signal that represents the position of the portion that the stylus pen 2 is contacting, the driving section 111 stores the contact position represented by the signal as the start point of the specified region. In addition, the CPU 201 stores, in the RAM 203, the position represented by the signal output from the touch panel 220 as the start point of the specified region (in step S103). The position specified with the stylus pen 2 by the user is retrieved by the touch panel 220 and the controller 200. Thus, the touch panel 220 and the controller 200 serve as a position retrieving section that retrieves the position specified with the stylus pen 2 by the user on the screen of the display device 100.

The CPU 201 then outputs, to the display device controller 110, a signal that instructs displaying an image G1 that represents the start point of the specified region (in step S104). When the display device controller 110 receives the signal from the CPU 201, the driving section 111 controls the address line driving section 101 and the data line driving section 102 so that the image G1 that represents the start point of the specified region is displayed. The position of the displayed image G1 corresponds to the position stored as the start point of the specified region in the driving section 111. The address line driving section 101 and the data line driving section 102 are controlled by the driving section 111 to drive only address lines and data lines that are to be used for displaying the image G1 and to thereby rewrite a part of the image of the image data. The image G1 that represents the start point of the specified region is superimposed on the image of the image data and displayed on the display device 100 at the position of the portion that the stylus pen 2 is contacting, i.e., at the start point of the specified region, as shown in FIG. 5.

Next, when the user moves the stylus pen 2 under the condition that the stylus pen 2 is in contact with the touch panel 220, the touch panel 220 outputs a signal that represents the position of a portion (of the touch panel 220) that the stylus pen 2 is contacting. After the CPU 201 terminates the processing of step S104, the CPU 201 receives the signal from the touch panel 220 (in step S105) and stores, in the RAM 203, the position represented by the signal output from the touch panel 220 as an end point of the specified region (in step S106). In addition, the CPU 201 outputs, to the display device controller 110, a signal that represents the end point of the specified region (in step S107). When this signal is input to the display device controller 110, the driving section 111 stores the position represented by the signal as the end point of the specified region. In addition, the CPU 201 sets a value of a display flag to “1” (that represents that the image is being displayed) and stores the set value of the display flag in the RAM 203 (in step S108).

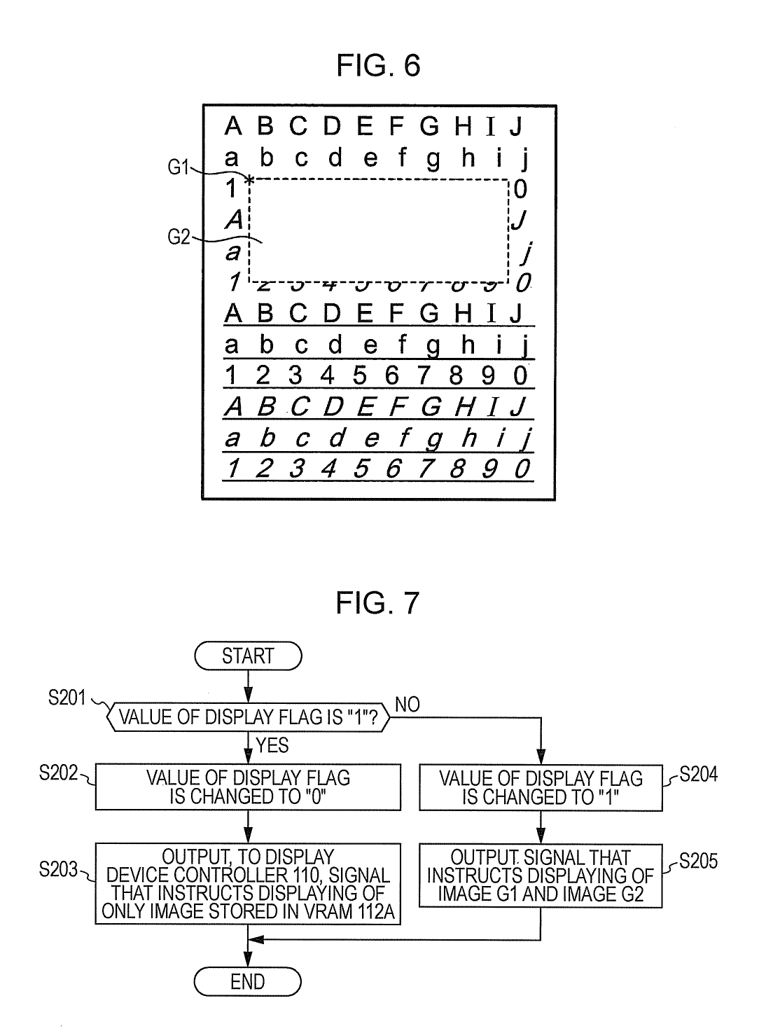

The CPU 201 then outputs, to the display device controller 110, a signal that instructs displaying of a rectangular image G2, which has a diagonal that connects the start point of the specified region to the end point of the specified region (in step S109). When this signal is input to the display device controller 110, the driving section 111 controls the address line driving section 101 and the data line driving section 102 so that the image G2 (having the diagonal that connects the start point of the specified region to the end point of the specified region) is displayed. The address line driving section 101 and the data line driving section 102 are controlled by the driving section 111 to drive only address lines and data lines that are to be used for displaying the image G2 and to thereby rewrite a part of the image of the image data. Then, the rectangular image G2 having a corner located at the position of the image G1 and a corner located at the contact position of the stylus pen 2 (that is contacting the portion of the touch panel 220 after the movement of the stylus pen 2) is superimposed on the image of the image data and displayed, as shown in FIG. 6. The color of the rectangular image G2 displayed on the display device 100 is white. Thus, a character image displayed in the rectangular region is hidden. In FIG. 6, the region of the image G2 is shown by a broken line to clarify the region of the image G2. The broken line, however, is not actually displayed on the display device 100.

When the user lifts up the stylus pen 2 from the touch panel 220 (in step S110), the CPU 201 performs a process shown in FIG. 7 at a predetermined time interval at which a timer interrupt occurs. Specifically, when the timer interrupt occurs, the CPU 201 confirms the value of the display flag. In this case, since the value of the display flag is “1” (or the answer in step S201 is affirmative), the CPU 201 changes the value of the display flag to “0” (in step S202). The CPU 201 then outputs, to the display device controller 110, a signal that instructs displaying of the image stored in the VRAM 112A (in step S203). When this signal is input to the display device controller 110, the driving section 111 controls the address line driving section 101 and the data line driving section 102 according to the image stored in the VRAM 112A. Then, voltages are applied to the address lines and the data lines so that the image (shown in FIG. 4) stored in the VRAM 112A is displayed on the display device 100. In this case, the address line driving section 101 and the data line driving section 102 are controlled by the driving section 111 to drive only address lines and data lines that are to be used for displaying the images G1 and G2 and to thereby rewrite a part of the image of the image data.

When a time predetermined as the time interval at which the timer interrupt occurs has elapsed and the timer interrupt reoccurs, the CPU 201 confirms the value of the display flag. In this case, since the value of the display flag is “0” (or the answer in step S201 is negative) as described above, the CPU 201 changes the value of the display flag to “1” (in step S204) and outputs, to the display device controller 110, a signal that instructs displaying of the images G1 and G2 (in step S205). When this signal is input to the display device controller 110, the driving section 111 controls the address line driving section 101 and the data line driving section 102 so that the images G1 and G2 are displayed. In this case, the address line driving section 101 and the data line driving section 102 are controlled by the driving section 111 to drive only address lines and data lines that are to be used for displaying the images G1 and G2 and to thereby rewrite a part of the image of the image data. Then, the images G1 and G2 are superimposed on the image shown in FIG. 4 and displayed as shown in FIG. 6. Since the process of the timer interrupt is performed at the predetermined time interval at which the timer interrupt occurs, the aforementioned operations are repeatedly performed so that an operation for displaying the images G1 and G2 and an operation for hiding the images G1 and G2 are alternately performed in a repeated manner. Thus, the images G1 and G2 are visually perceived by the user as if the images G1 and G2 blink.

For example, when the operating section 230 is operated by an operation for giving an instruction to hide, or erase, an image located in the region of the image G2, the CPU 201 writes, into the VRAM 112A, a white image having a diagonal that connects the start point (stored in the RAM 203) of the specified region to the end point (stored in the RAM 203) of the specified region. Then, when the CPU 201 outputs, to the display device controller 110, a signal that instructs displaying of the image stored in the VRAM 112A, the driving section 111 controls the address line driving section 101 and the data line driving section 102 according to the image stored in the VRAM 112A. Voltages are then applied to the address lines and the data lines so that the image stored in the VRAM 112A is displayed on the display device 100 to hide, or erase, the image located in the region of the image G2.

In the embodiment, since the color of the image displayed in the region selected by the user is white, an image that represents the region does not remain in the region selected by the user, and the displayed image is not degraded compared with image degradation that occurs when a black frame is displayed to represent the region selected by the user. In addition, since the white image blinks in the region selected by the user, the white image allows the user to visually perceive the selected region.

### Modified Example

The embodiment of the invention is described above. The invention is not limited to the aforementioned embodiment and may be applied to other embodiments. For example, the embodiment may be modified as follows, and the invention may be applied to the modified example. The embodiment described above and the modified example described below may be combined.

In the aforementioned embodiment, the image G1 is displayed at the start point of the specified region. The image G1, however, does not have to be displayed.

In the aforementioned embodiment, the operation for displaying the images G1 and G2 and the operation for hiding the images G1 and G2 are alternately performed in a repeated manner at the predetermined time interval. The process of the timer interrupt, however, does not have to be performed so that the images G1 and G2 may remain displayed without being hidden.

In the embodiment, the operation for displaying the images G1 and G2 and the operation for hiding the images G1 and G2 may be alternately performed in a repeated manner at the predetermined time interval until the stylus pen 2 is lifted up from the touch panel 220, i.e., during the operation for specifying the region. In this case, the time interval at which the operation for displaying the images G1 and G2 and the operation for hiding the images G1 and G2 are alternately performed during the contact of the stylus pen 2 with the touch panel 220 (or during the operation for specifying the region) may be different from the time interval at which the operation for displaying the images G1 and G2 and the operation for hiding the images G1 and G2 are alternately performed after separating the stylus pen 2 from the touch panel 220 (or after the operation for specifying the region).

In the embodiment, the color of a character located in the region specified by the user may be gray.

In the embodiment, an operation for displaying only an edge of the image G2 and an operation for hiding the outline of the image G2 may be alternately performed.

In the embodiment, the display device 100 displays white, black and gray images. However, the display device 100 may display images of other colors.

In the embodiment, the image G1 is displayed in black, while the image G2 is displayed in white. However, the images G1 and G2 may be displayed in an intermediate gradation (e.g., gray).

In the embodiment, the CPU 201 may calculate the area of a black part of the image written in the VRAM 112A and the area of a white part of the image written in the VRAM 112A before displaying the image G2. Then the CPU 201 compares the area of the black part with the area of the white part. When the area of the black part is larger than the area of the white part, the CPU 201 may make the image G2 to be displayed in black. When the area of the white part is larger than the area of the black part, the CPU may make the image G2 to be displayed in white.

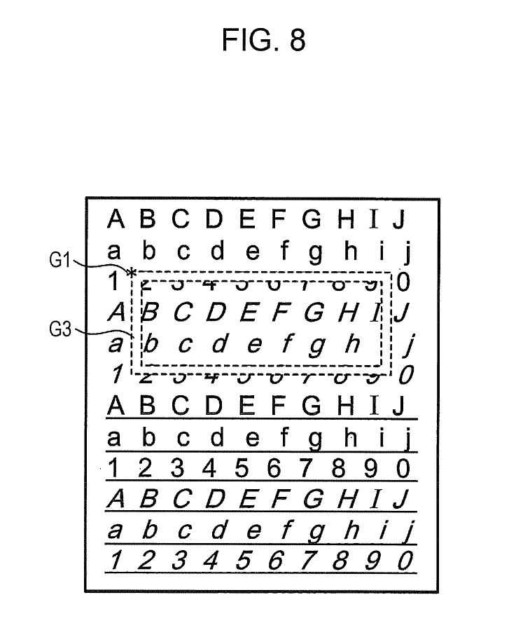

In the embodiment, the rectangular white image G2 is displayed in the region specified by the user. As shown in FIG. 8, a white rectangular frame-shaped image G3 having a diagonal that connects the start point of the specified region to the end point of the specified region may be displayed instead of the image G2. In FIG. 8, the region of a white frame that forms the image G3 is shown by broken lines to clarify the image G3. The broken lines, however, are not actually displayed on the display device 100. An operation for displaying the white image G3 and an operation for hiding the white image G3 may be alternately repeated at a predetermined time interval. When the image G3 is displayed, a black cross-shaped image or black or gray square bracket may be displayed at the position of the corner of the image G3. The image G3 may be displayed so that the width of a frame portion (of the image G3) located near the corner of the image G3 is larger than the width of the other frame portions of the image G3.

In the embodiment, the controller 200 and the display device controller 110 are located in respective blocks that are separated from each other. The controller 200 and the display device controller 110 may be located in a single block and serve as a controller that controls the display device 100. In the embodiment, since the controller 200 and the display device controller 110 control the display device 100, it can be said that the controller 200 and the display device controller 110 serve as a controller that controls the display device 100.

In the embodiment, the electrophoretic display device is used as the display device 100. The invention is applicable to another display device on which a ghost of an image may be generated. For example, an electrochromic display device on which a ghost of an image may remain may be used as the display device 100. As is well known, when a voltage is applied between two electrodes that sandwich an electrochromic material, a current flows in the electrochromic material so that the electrochromic material emits a specific color. When the reversed voltage is applied between the two electrodes, a current flows in the opposite direction in the electrochromic material so that the color disappears. An image that is displayed on a display device having an electrochromic material remains on the display device, even when an operation for making a current to flow in the electrochromic material is stopped. When the image is erased, a ghost of the image remains in a similar manner to the electrophoretic display device. When the information display apparatus 1 includes an electrochromic display device (instead of the electrophoretic display device) having a plurality of pixels that are driven by a matrix driving scheme, the invention is applicable to the information display apparatus 1. The electrophoretic display device used in the embodiment uses white and black colors to display an image. The electrochromic display device is different from the electrophoretic display device in that the electrochromic display device displays an image tincted with a color specific to an electrochromic material and an image untincted with the color specific to the electrochromic material. The tincted image and the untincted image displayed on the electrochromic display device correspond to the black image and the white image displayed on the electrophoretic display device, respectively. The invention is not limited to the electrophoretic display device and the electrochromic display device. The invention is applicable to any display device (such as a display device having ferroelectric liquid crystal) on which a ghost of an image may be generated.

The entire disclosure of Japanese Patent Application Nos. 2009-134770, filed Jun. 4, 2009 and 2010-006563, filed Jan. 15, 2010, are expressly incorporated by reference herein.

What is claimed is:

1. A display apparatus, comprising:
a display device on which a tincted, including black, image is displayed;
a position retrieving section that retrieves a position specified on a screen of the display device; and
a controller that uses the position retrieved by the position retrieving section to identify a region specified on the screen of the display device and controls the region identified on the display device so that a untincted figure that is formed in a predetermined shape is displayed in the identified region.

2. The display apparatus according to claim 1, wherein
the controller controls the region identified on the display device so that an operation for displaying the figure and an operation for hiding the figure are alternately performed at a predetermined time interval.

3. A display apparatus comprising:
a display device on which a tincted, including black, image is displayed;
a position retrieving section that retrieves a position specified on a screen of the display device; and
a controller that uses the position retrieved by the position retrieving section to identify a region specified on the screen of the display device and controls the region identified on the display device so that either a tincted figure that is formed in a predetermined shape or a untincted figure that is formed in a predetermined shape is displayed in the identified region on the basis of the ratio of the area of a tincted portion of the image displayed on the display device to the area of a untincted portion of the image displayed on the display device.

4. The display apparatus according to claim 3, further comprising:
an operating section that is operated by an operation; and
a storage section that stores image data that represents the image, wherein
the controller controls the display device, on the basis of the operation, to make the image represented by the image data stored in the storage section to be displayed on the display device and controls the region identified on the display device so that the untincted figure is displayed when the area of the untincted portion is larger than the area of the tincted portion and that the tincted figure is displayed when the area of the untincted portion is not larger than the area of the tincted portion.

5. The display apparatus according to claim 3, wherein
the controller controls the region identified on the display device so that an operation for displaying the untincted figure or the tincted figure and an operation for hiding the untincted figure or the tincted figure are alternately performed at a predetermined time interval.

6. The display apparatus according to claim 1, wherein
a ghost of the image remains on the display device when the image displayed on the display device is hidden.

7. The display apparatus according to claim 6, wherein
the display device is an electrophoretic display device.

8. The display apparatus according to claim 6, wherein
the display device is an electrochromic display device.
